(19) United States
(12) Patent Application Publication
(10) Pub. No.: US 2007/0223721 A1
(43) Pub. Date: Sep. 27, 2007

(54) SELF-TESTING PROGRAMMABLE LISTENING SYSTEM AND METHOD

(76) Inventors: Michael J. Stern, Thousand Oaks, CA (US); Jack Goldberg, San Diego, CA (US)

Correspondence Address: IP LEGAL TEAM, PLLC, P.O. BOX 170440, BOISE, ID, 83716, US

(21) Appl. No.: 11/682,844

(22) Filed: Mar. 6, 2007

Related U.S. Application Data
(60) Provisional application No. 60/779,758, filed on Mar. 6, 2006.

(51) Int. Cl. H04R 1/10; H04R 25/00

(52) U.S. Cl. 381/74; 381/384

(57) ABSTRACT

A self-testing programmable listening system includes a programmable listening device and a programming module, which may be located within the listening device or in an external module configured to communicate with the listening device via a suitable wireless or wired communication link. When the listening device is in programming mode, the programming module delivers test prompts to the user through the listening device and programs the signal processing characteristics of the device based on the user's responses to the test prompts.

### CROSS-REFERENCE

This application claims priority to U.S. Provisional Patent Application No. 60/779,758, filed Mar. 6, 2006 and entitled SELF-TESTING HEARING SYSTEM AND METHOD. The application is also related to co-pending U.S. patent application Ser. No. ______, filed concurrently herewith and entitled HEADWORN LISTENING DEVICE AND METHOD. The disclosures of these related applications are hereby incorporated by reference in their entireties.

### BACKGROUND

The present application relates generally to listening devices such as hearing aids and, more particularly, to listening devices capable of administering tests to facilitate device programming.

Hearing aid fitting generally involves a hearing health professional, such as a hearing aid dealer, audiologist or otolaryngologist or the like. This individual typically tests the hearing of his or her client with an audiometer. Most audiometers perform this hearing test under earphones. Some, however perform the hearing test in a sound field (speakers placed in a room with little or no reflection). The hearing health professional then records the hearing thresholds of the client, that is the levels at which pure tones are just audible, for various frequencies ranging generally from 125 Hz to 8000 Hz. He or she may also measure the dynamic range of hearing at various frequencies (both softest and loudest sound levels that the user can comfortably hear). In addition, the hearing health professional may conduct speech listening tests to evaluate the client's ability to understand speech under various circumstances.

With the above audiometric information, a hearing aid can be manufactured and configured to accommodate the measured loss characteristics of the client. The hearing aid is generally a very small device, generally inserted into the user's ear canal and housed in a custom fitted case or shell that matches the shape of the user's ear canal.

The manufactured hearing aid will thus physically fit into the ear canal of the user and should significantly ameliorate the user's hearing difficulty because it is configured with knowledge of the measured audiometric information. Upon delivery of the hearing aid, there is often final “tweaking” to ensure both a good physical fit and a comfortable fit with respect to the signal processing.

Listening devices are available which may assist users in understanding speech in noisy environments or protect users from loud sounds. These devices often have insufficient signal processing to address common use conditions and offer very few, if any, programming choices.

### SUMMARY

In one embodiment, a listening device comprises an input transducer configured to receive acoustic input signals and a signal processor operatively connected to the input transducer and having programmable signal processing characteristics. The listening device further comprises an output transducer operatively connected to the signal processor and configured to generate an audio output signal, as well as a mode selector causing the listening device to enter a programming mode when actuated. The output transducer is configured to generate a series of test prompts to which the user responds when the listening device is in programming mode, and the processing characteristics of the signal processor are configured to be programmed based on signals received from the user in response to the test prompts.

In another embodiment, a method for programming a listening device comprises providing a listening device with a programmable signal processor and an output transducer for generating sound delivered to a user. A test is administered to the user with the listening device in place on or in the user's ear, using test prompts delivered through the output transducer via a non-acoustic signal path. The signal processor is programmed based on the user's responses to the test prompts delivered through the output transducer.

In another embodiment, a system for programming a listening device comprises a microcontroller configured to program the signal processing characteristics of the listening device and a memory operatively connected to the microcontroller, the memory storing a plurality of test prompts. The system further comprises means for presenting the test prompts to the user through the listening device via a non-acoustic signal path and means for receiving the user's responses to the test prompts for use by the microcontroller in programming the signal processing characteristics of the listening device.

These and other embodiments of the present application will be discussed more fully in the detailed description. The features, functions, and advantages can be achieved independently in various embodiments of the present application, or may be combined in yet other embodiments.

### BRIEF DESCRIPTION OF DRAWINGS

FIG. 1A is a block diagram of a listening system with a programming module contained within a listening device.

FIG. 1B is a block diagram of a listening system with an external programming module in communication with a listening device via a wireless link.

FIG. 1C is a block diagram of a listening system with an external programming module in communication with a listening device via a wired link.

FIG. 2 is an external view of an embodiment of a programmable listening device.

FIG. 3 is a view of an embodiment of a programmable listening device in place on a user's head.

FIG. 4 is a block diagram of the electronic circuitry of a programmable listening device.

FIG. 5 is a block diagram of the electronic circuitry of an external programming module for use with a programmable listening device.

FIG. 6A is an illustration of an embodiment of a programmable listening system with user controls for self-testing and programmability self-contained in the listening device.

FIG. 6B is an illustration of an embodiment of a programmable listening system with user controls for self-testing and programmability linked by wire to the listening device.

FIG. 6C is an illustration of an embodiment of a programmable listening system with user controls for self-testing and programmability wirelessly linked to the listening device.

FIG. 7A is an illustration of another embodiment of a programmable listening system with user controls for self-testing and programmability self-contained in the listening device.

FIG. 7B is an illustration of another embodiment of a programmable listening system with user controls for self-testing and programmability linked by wire to the listening device.

FIG. 7C is an illustration of another embodiment of a programmable listening system with user controls for self-testing and programmability wirelessly linked to the listening device.

FIG. 8A is an illustration of yet another embodiment of a programmable listening system with user controls for self-testing and programmability self-contained in the listening device.

FIG. 8B is an illustration of yet another embodiment of a programmable listening system with user controls for self-testing and programmability linked by wire to the listening device.

FIG. 8C is an illustration of yet another embodiment of a programmable listening system with user controls for self-testing and programmability wirelessly linked to the listening device.

### DETAILED DESCRIPTION

In the following detailed description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that various changes may be made without departing from the spirit and scope of the present invention. The following detailed description is, therefore, not to be taken in a limiting sense.

This application relates to a self-testing programmable listening system for processing sound or other sonic information with applicability in situations where there is difficulty perceiving that sound or information. The system includes a programmable listening device that is preferably comfortable to wear and easy to adjust and use. Several exemplary embodiments will be described to illustrate various features and advantages of the system.

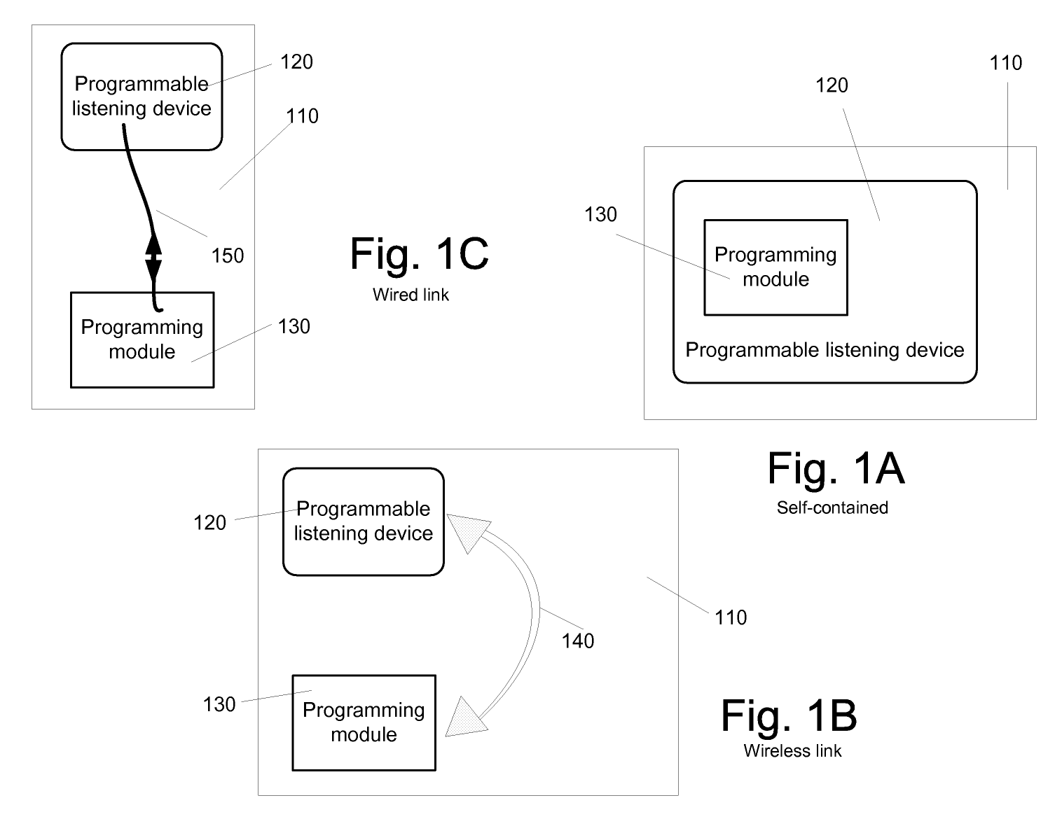

FIGS. 1A, 1B and 1C are block diagrams of three exemplary embodiments of a listening system 110 comprising a programmable listening device 120 and a programming module 130. The programming module 130 comprises a combination of hardware and software elements, such as user controls (e.g., switches, pushbuttons, potentiometers, optional input transducers, etc.), memory, processor, etc., associated with self-test and programming of the programmable listening device 120.

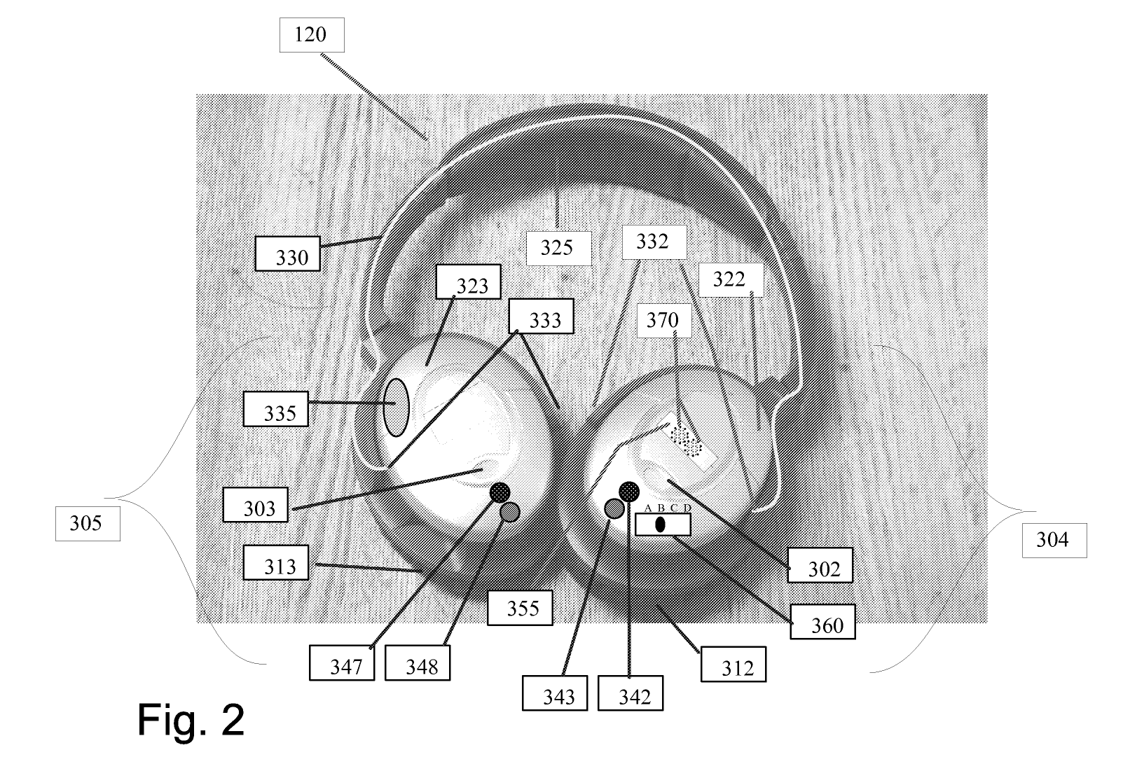

In the embodiment illustrated in FIG. 1A, the programming module 130 is self-contained within the programmable listening device 120, meaning that the user controls and other components are located on or in the device itself. In the embodiment illustrated in FIG. 1B, the programming module 130 is external to the programmable listening device 120 and communicates with it via a suitable wireless link 140, such as, for example, a Bluetooth or an infrared communication link. In the embodiment illustrated in FIG. 1C, the programming module 130 is external to the programmable listening device 120 and communicates with it via a wired link 150, such as, for example, a USB or other multi-conductor cable. FIG. 2 illustrates an exemplary embodiment of a programmable listening device 120. In the illustrated embodiment, the listening device 120 is configured as a headset comprising a right side 304 and a left side 305 interconnected with a headband 325. The left side 305 of the listening device 120 comprises, inter alia, left-side assembly 323, left input transducer assembly 303, left ear cushion 313, and left side user controls 347 and 348. Battery panel 335, when lifted, allows the user to access the batteries. The right side 304 of the listening device 120 comprises, inter alia, right-side assembly 322, right input transducer assembly 302, right ear cushion 312, and right side user controls 342, 343, 360 and 370. When panel 355 is removed, user controls 370 which enable the self-testing and programmability features, are revealed.

In the illustrated embodiment, the headband 325 is intended to be worn on a user's head. In other embodiments, the headband 325 may wrap behind the user's neck, hang under the user's chin, or may be configured in a variety of other suitable ways to keep the earphones in place on or in the user's ears. Alternatively, the earphones may be designed to remain in place on or in the user's ears without a headband 325. In such embodiments, the right earphone and left earphone may function independently, or they may communicate with each other using a wireless communication link, such as a Bluetooth connection.

The earphones shown in FIG. 2 are of the circumaural type, meaning that the user's ears fit comfortably within the right ear cushion 312 and left ear cushion 313, respectively, when the listening device 120 is in use. The ear cushions 312 and 313 may be foam-filled or liquid-filled and covered with a resilient material, preferably providing an acoustic seal sufficient to prevent feedback. In other embodiments, the listening device may take on a wide variety of other suitable configurations, such as, for example, earbuds, supra-aural earphones, canalphones, in-ear monitors, etc.

Pushbuttons 342 and 343 may adjust right volume up and right volume down, respectively. Pushbuttons 347 and 348 may adjust left volume up and left volume down, respectively. Alternatively, pushbuttons 342, 343, 347 and 348 may adjust volume and balance. Multiple-position switch 360 selects one of a plurality of signal processing settings. Right input transducer assembly 302 comprises at least one input transducer, an input transducer mount, and an input transducer cover which protects the input transducer(s) inside from moisture and dirt while allowing sound to pass through. Similarly left input transducer assembly 303 comprises at least one input transducer, an input transducer mount and an input transducer cover. In this particular embodiment, headband 325 attaches to both the right- and left-side assemblies at pivot points 332 and 333, respectively. Interconnecting wires 330 connect signal and control lines between right 304 and left 305 sides of the headset and are routed through a pivot point on the right side, through the headband 325, and through a pivot point on the left side.

In the illustrated embodiment, the listening device 120 comprises a 4-position switch 360. This switch 360 selects one of four signal processor settings which may be applicable to different listening needs and situations. For example, there may be a setting for reducing low frequencies, which may be preferable in a noisy environment, such as in an automobile or a crowded restaurant. The user is guided in this setting by what he or she thinks sounds best in a particular listening situation.

The listening device 120 preferably includes a panel 355 under which is located at least one mode selector (e.g., a control switch or pushbutton) for use in during self-test or programming the signal processing characteristics for both the right and left ears. In some embodiments, the mode selector is included within the user controls 370 described above. When actuated, the mode selector causes the listening device 120 to enter a “programming” mode, in which the listening device 120 administers an in-situ test to the user and programs its signal processing characteristics based on the user's responses. The mode selector may be actuated using a variety of suitable techniques, such as, for example, manual actuation of a physical switch or pushbutton, electronic actuation of a control switch, or execution of a software interrupt.

It is preferred that the internal signal processing characteristics be matched as closely as possible to the desired functionality of the listening device 120 and to the hearing characteristics of the user. Thus, in some embodiments, when the listening device 120 is in programming mode, the programming module 130 administers an in-situ test under the control of firmware which is intuitive to use and guides the user toward the most efficacious setting of both the right and left signal processing characteristics. In some embodiments, when the listening device 120 is in programming mode, the user provides responses to the programming module 130 via controls, such as, for example, switches, pushbuttons, potentiometers, or input transducers which enable voice-activated user control. As described above, the controls of the programming module 130 may be self-contained within the listening device 120 or may be located in an external device.

Different arrangements of user controls 370 may be included under panel 355, depending upon the precise steps the user takes to configure the listening device 120 to most effectively process sound or other acoustic information. Following the removal or opening of panel 355, the user controls 370 located under the panel 355 are preferably easily accessible and adjustable while the headset is in position on the user's head, as he or she cannot see the controls 370 while adjusting them. Different arrangements of user controls 370 and the steps involved in programming the listening device 120 will be discussed below.

For example, in some embodiments, the user controls 370 comprise two pushbuttons located under panel 355, and pressing one of the two pushbuttons causes the listening device 120 to enter the programming mode by initiating communication between the listening device 120 and an external programming module via a Bluetooth wireless connection or the like. A wired connection may alternatively be employed, with a connector (USB for example) being available under panel 355. With an external programming module, the controls are more easily accessible and controllable by the user during the setup process.

In some embodiments, right- and left-side assemblies 322 and 323 include various electronic components, such as, for example, a signal processor, a microcontroller, and a wireless communication device, such as a Bluetooth transceiver. In operation, the signal processor(s) process the signals from the input transducers enabling the user to perceive sound or other acoustic information detected by the input transducers. In some embodiments, Bluetooth communication enables an external programming module, also containing Bluetooth capability, to communicate with the listening device 120 for purposes of testing or configuring the device 120.

When the listening device 120 is in the programming mode, the device 120 delivers test prompts (e.g., test stimuli, instructions, questions, etc.) to the user through its output transducers. These test prompts are generated electronically and connected to the output transducers via a non-acoustic signal path, rather than being detected acoustically by input transducers, as can be the case in sound-field audiometric testing. The test prompts are therefore stored in some form within the programming module 130 of the listening system 1 10, for example as digitized audio, and are played during self-test and programming by, for example, a microcontroller. As described above, the programming module 130 (and thus the source of the test prompts) may be located within the programmable listening device 120 or within an external programming device linked in some manner to the listening device 120.

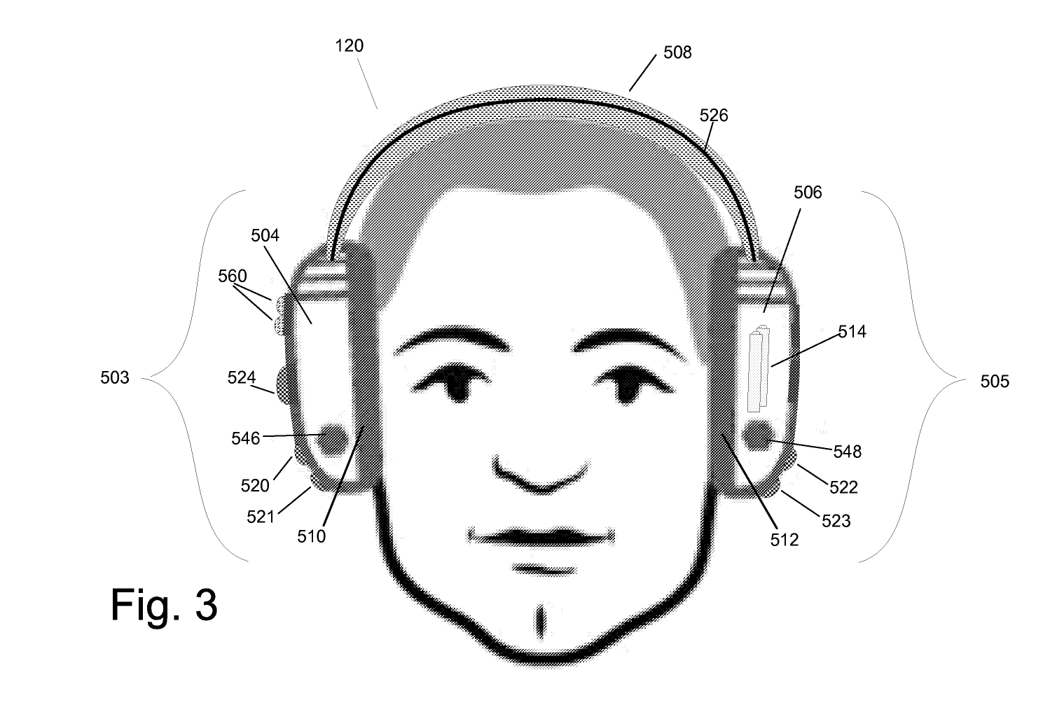

FIG. 3 is a view of an embodiment of a listening device 120 in place on a user's head. In the illustrated embodiment, the listening device 120 is configured as a headset comprising a right side 503, a left side 505 and a headband 508. The right side of the headset comprises right-side assembly 504, right input transducer assembly 546, right ear cushion 510, and right-side user controls 520, 521, 524 and 560, as well as the right speaker and right circuit board and other items not shown in the figure. The left side of the headset comprises left-side assembly 506, left input transducer assembly 548, left ear cushion 512 and left-side user controls 522 and 523, as well as the left speaker and other items not shown in the figure. In this particular embodiment, the batteries 514 are housed in the left side of the headset.

Pushbuttons 520 and 521 may adjust right volume up and right volume down, respectively. Pushbuttons 522 and 523 may adjust left volume up and left volume down, respectively. Alternatively, pushbuttons 520, 521, 522 and 523 may adjust volume and balance. Multiple-position switch 524 selects one of a plurality of signal processing settings. User controls 560 may be located beneath a panel (such as panel 355 of FIG. 2) and these controls 560 may be utilized for the self-test and programmability features of the listening device 120.

Right input transducer assembly 546 comprises at least one input transducer, an input transducer mount, and an input transducer cover which protects the input transducer(s) inside from moisture and dirt while allowing sound to pass through without significant attenuation. Similarly left input transducer assembly 548 comprises at least one input transducer, an input transducer mount and an input transducer cover. Interconnecting wires 526 connect signal and control lines between right 503 and left 505 sides of the headset.

Housed within right- and left-side assemblies 504 and 506 are various electronic components including at least one signal processor. For applications involving the processing of sound in the range of human hearing, the input transducers which are part of assemblies 546 and 548 may be microphones. For applications involving the processing of infrasonic information, assemblies 546 and 548 comprise specialized infrasonic microphones or transducers and for applications involving the processing of ultrasonic information, assemblies 546 and 548 comprise specialized ultrasonic microphones or transducers.

In operation, the signal processor(s) process the signals from the input transducers enabling the user to perceive sound or sonic information detected by the input transducers. If that sound or sonic information encompasses a frequency range beyond that of human hearing, the signal processor(s) comprise a frequency translation or information coding scheme to allow the user to hear the desired sound or sonic information. An example of a suitable frequency translation circuit is described in U.S. Pat. No. 5,289,505, entitled “Frequency translation circuit and method of translating,” by Durec.

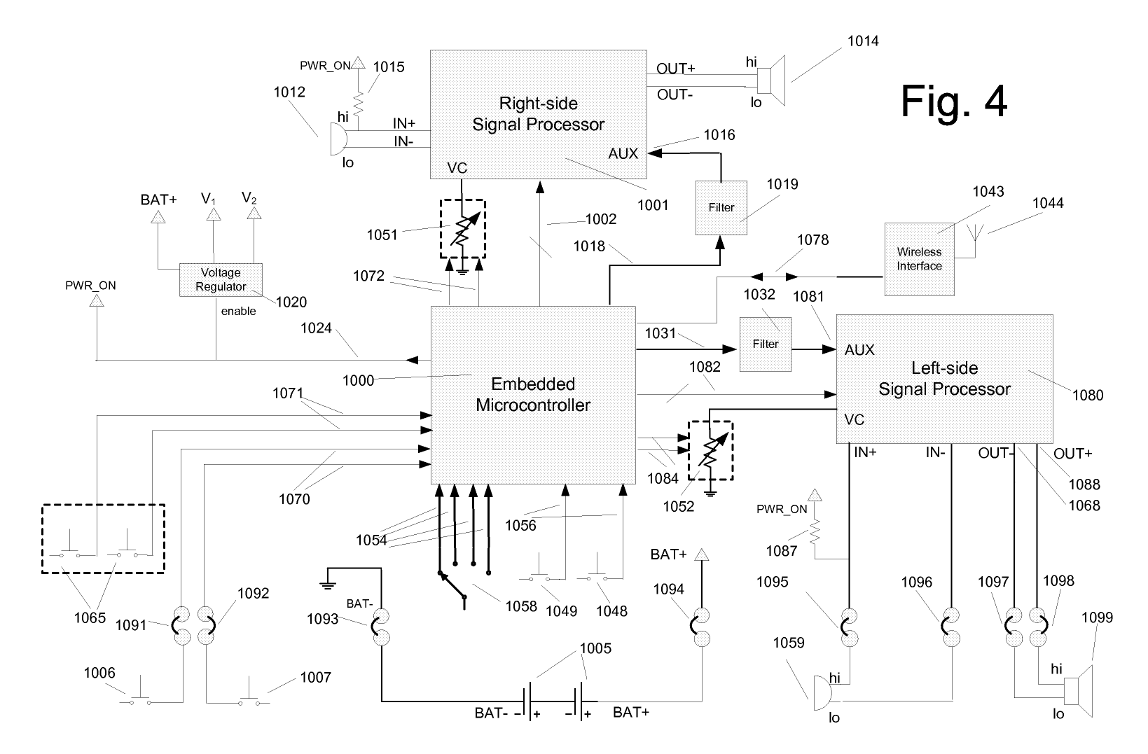

A block diagram of one embodiment of the electronic circuitry of the listening device 120 is shown in FIG. 4. Eight wires interconnect the right and left sides of the listening device 120. The left side of the listening device 120 contains a small number of electronic components: LEFT UP and LEFT DOWN pushbuttons 1006 and 1007 respectively, batteries 1005, left speaker 1099, and left microphone 1059. The eight interconnecting wires are labeled 1091 through 1098. The table below lists the function of each interconnect terminal pair.

| Interconnect | Function |
|---|---|
| 1091 | left up volume pushbutton |
| 1092 | left down volume pushbutton |
| 1093 | battery negative |
| 1094 | battery positive |
| 1095 | left microphone high |
| 1096 | left microphone low |
| 1097 | left speaker low |
| 1098 | left speaker high |

With reference to FIG. 4, this embodiment utilizes signal processors 1001 and 1080, which may comprise, for example, the model GB3215, supplied by Gennum Corporation, Burlington, Ontario, Canada. The right side electronics of the listening device 120 comprises an embedded microcontroller 1000 which is powered via the battery negative and battery positive connections, BAT− and BAT+. Batteries 1005, for example two AAA batteries connected in series, are located in the left side. Embedded microcontroller 1000 preferably comprises program memory, non-volatile data memory, digital input/output lines, timing and counting elements, circuitry for generation of pulse-width modulated outputs, and an integrated oscillator to supply the clock signal for microcontroller operation. An example of a microcontroller suitable for this embodiment is the PIC18LF4520 supplied by Microchip Technology Inc., Chandler, Ariz. Right- and left-side signal processors may be identical.

Right side user controls 1048, 1049, 1058 and 1065 connect directly to microcontroller inputs via lines 1054, 1056 and 1071, respectively. Pushbutton 1049 may provide the right-side volume up function and pushbutton 1048 may provide the right-side volume down function. Multiple-position switch 1058 selects one of a plurality of signal processing settings. Left-side user pushbuttons 1006 and 1007 connect to microcontroller inputs via lines 1070 and may provide the left-side volume up and volume down functions. Pushbuttons 1065 may be located beneath a panel (e.g., panel 355 shown in FIG. 2), and these controls may be utilized for the self-test and programmability features of the listening device 120.

Microcontroller 1000 controls the processing characteristics of right side signal processor 1001 via output lines 1002 and controls the processing characteristics of left-side signal processor 1080 via output lines 1082. Signal processors 1001 and 1080 both comprise VC (volume control) connections and volume may be controlled by providing a variable resistance attached to the VC connection. In order for microcontroller 1000 to control right-side volume, output lines 1072 connect to digital volume control 1051. Similarly, in order to control left-side volume, microcontroller output lines 1084 connect to digital volume control 1052. Volume controls 1051 and 1052 may be, for example, the model MCP4011E supplied by Microchip Technology Inc., Chandler, Ariz. Control inputs to volume controls 1051 and 1052 allow the volume to be adjusted up or down electronically.

A source of power for signal processors 1001 and 1080 and for other components within the embodiment illustrated in FIG. 4 is voltage regulator 1020 which may comprise, for example, the LT1761ES5-SD supplied by Linear Technology Corporation, Milpitas, Calif. Voltage regulator 1020 is connected to both the positive and negative terminals of the battery, labeled BAT+ and BAT−, respectively, and regulator 1020 generates output voltages V₁ and V₂. Regulator 1020 comprises an enable input which connects to microcontroller output line 1024, labeled as PWR_ON. When line 1024 is high, voltage regulator 1020 supplies its output voltages.

In the embodiment of FIG. 4, right-side signal processor 1001 is connected to microphone 1012 and left-side signal processor 1080 is connected to microphone 1059. Right-side signal processor 1001 is connected to right speaker 1014 and left digital signal processor is connected to left speaker 1099. At its output terminals, labeled OUT+ and OUT−, right-side signal processor 1001 is connected to speaker 1014. Left-side signal processor 1080 is connected to speaker 1099. Speakers 1014 and 1099 may be 32 ohm headphone speakers having a diameter of 50 millimeters, for example.

In some embodiments, microphones 1012 and 1059 may be omnidirectional two-terminal electret microphones having a diameter of 6 millimeters. The high and low terminals of right microphone 1012 are connected to the IN+ and IN− pins of signal processor 1001. The high terminal of right microphone 1012 is also connected to a power source via resistor 1015. Similarly the high and low terminals of left microphone 1059 are connected to signal processor 1080 and the high terminal is also connected to a power source via resistor 1087. In the illustrated embodiment, microphone power is supplied by the PWR_ON microcontroller output signal 1024 and resistors 1015 and 1087 are each 3.3K ohms. This PWR_ON signal is also wired to the enable input of voltage regulator 1020, as discussed above. Thus when PWR_ON is set low, no power is supplied to either of the microphones, to either signal processor, or to any other circuitry outside microcontroller 1000. Further, microcontroller 1000, which is always connected to the battery voltage BAT+, may be set to an extremely low power “sleep” state under firmware control. Consequently, when PWR_ON is set low, an extremely low amount of current is drawn from the batteries.

The microcontroller output at line 1018 may be a modulated logic signal, which, when processed by filter 1019, can provide an auxiliary signal to AUX input 1016 of right-side signal processor 1001. Similarly, the microcontroller output at line 1031 may be a modulated logic signal, which, when processed by filter 1032, can provide an auxiliary signal to AUX input 1081 of left-side signal processor 1080. These auxiliary signals may be, for example, tones at a predetermined frequency and volume. Alternatively, an auxiliary signal may be a speech signal which can be understood by the user. Auxiliary signals may provide an alert indicating certain conditions, such as a weak or dead battery or may provide instructions or stimuli to facilitate self-test and programmability features of the listening device 120. A wide variety of signals, including speech-like signals, may be produced at the outputs of filters 1019 and 1032 depending on the modulation characteristics of the microcontroller output signals 1018 and 1031 respectively. In the case where microcontroller 1000 is the PIC18LF4520, pulse-width modulated outputs (PWM) are available which greatly increases the variety of auxiliary signals which may be easily produced.

In the illustrated embodiment, microcontroller 1000 communicates with wireless interface 1043, for example a Bluetooth transceiver, via control lines 1078. An antenna 1044 suitable for the particular wireless interface employed is connected to interface 1043. This arrangement enables microcontroller 1000 to receive data from or send data to an external programming module 130 to facilitate the self-test and programmability features of the listening device 120. Data received may be representative of stimuli or instructions to be used during self-test or may be information which specifies signal processing characteristics to be configured.

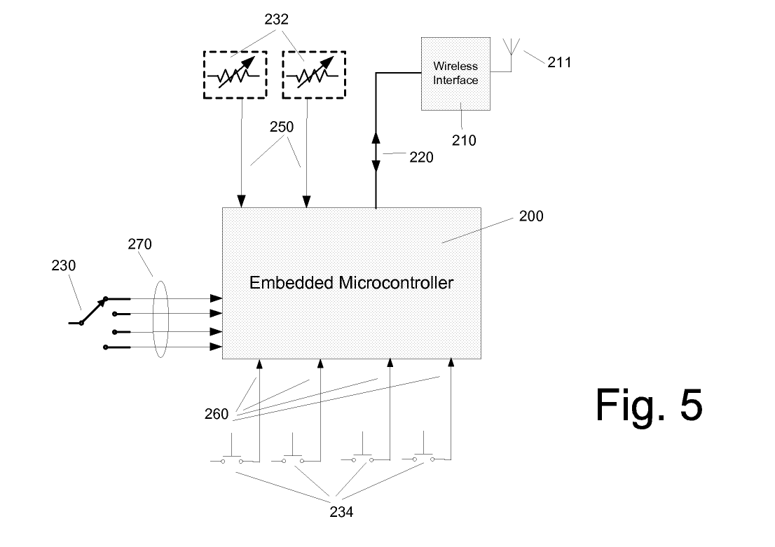

A block diagram of one embodiment of the electronic circuitry of an external programming module 130 is shown in FIG. 5. In this embodiment, the external programming module 130 has the capability to wirelessly communicate with the programmable listening device 120 and may be utilized to select the most efficacious signal processing configuration of the listening device 120. Not shown in the figure, this external programming module 130 comprises a power supply, for example batteries or circuitry connected to a source of power such as common 110 VAC. Additionally, the programming module 130 comprises various user-operable controls 230, 232, and 234 as well as a wireless interface, such as, for example, a Bluetooth transceiver 210.

As shown in the figure, the programming module 130 comprises an embedded microcontroller 200 which has input pins 250, 260 and 270. Microcontroller lines 250 are analog inputs to an integrated analog-to-digital converter within microcontroller 200. Thus microcontroller 200 can determine the setting of potentiometers 232. Microcontroller input lines 260 are connected to user-operable pushbuttons 234 and microcontroller input lines 270 are connect to user-operable multiple-position switch 230. Microcontroller 200 may be, for example, the model PIC18LF4520 supplied by Microchip Technology Inc., Chandler, Ariz.

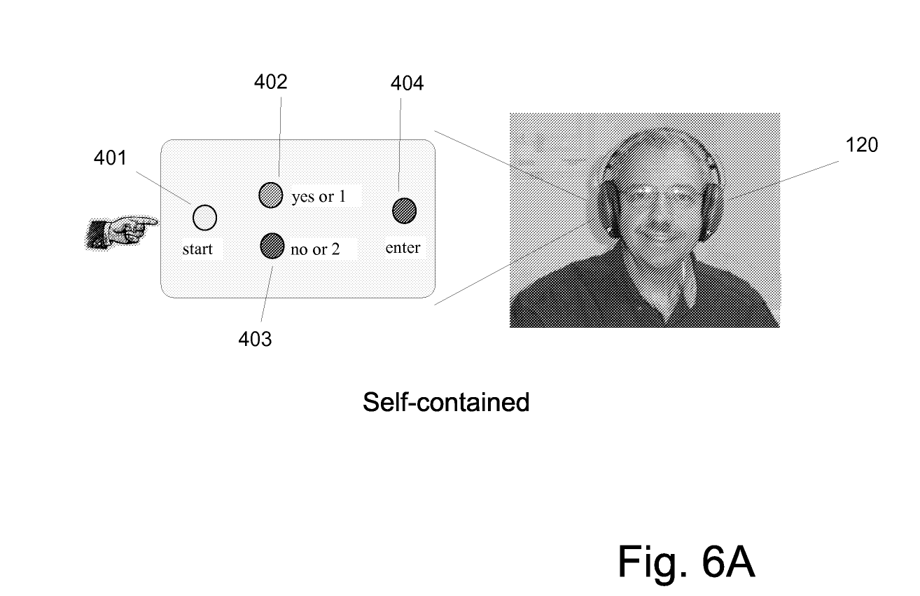

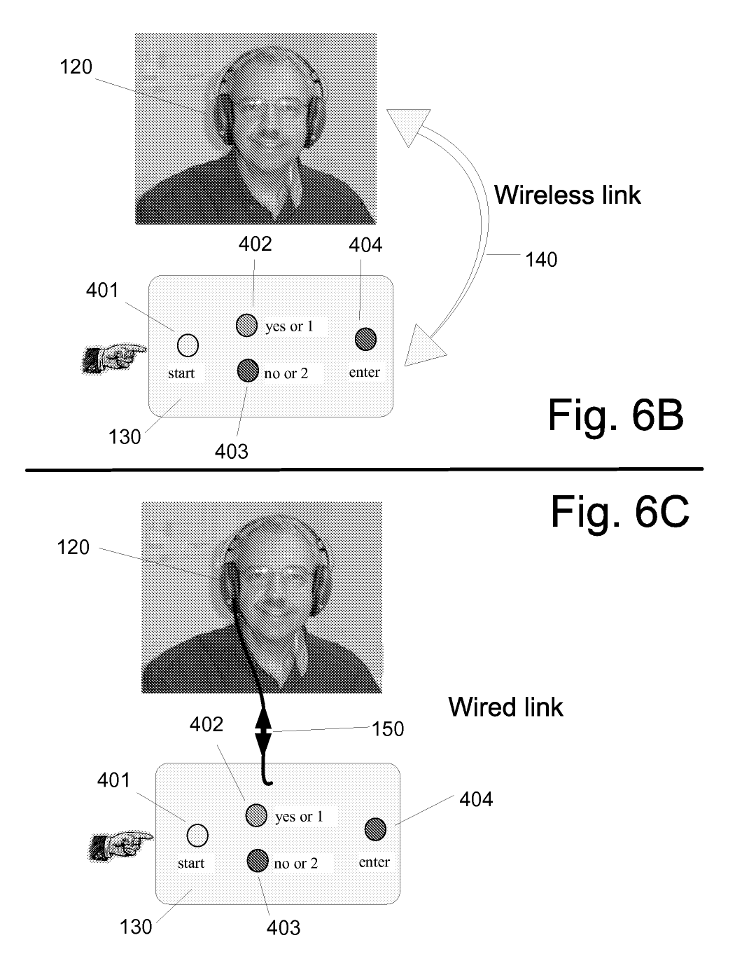

FIGS. 6A, 6B and 6C illustrate an exemplary configuration of user-operable controls that may be employed during self-test and programming of a listening device 120. In FIG. 6A, listening device 120 comprises user-operable controls 401 through 404 which may be located under a panel (such as panel 355 of FIG. 2) and are accessed only when the user wishes to cause the device 120 to enter programming mode. In FIG. 6B, user-operable controls 401 through 404 are located in an external programming module 130 which communicates with the listening device 120 via a wireless link 140. In FIG. 6C, user-operable controls 401 through 404 are located in an external programming module 130 which communicates with the listening device 120 via a wired link 150.

In this particular embodiment, user-operable controls 401 through 404 comprise four pushbuttons. Pushbutton 401 is the START button, pushbutton 402 is used to indicate a YES or 1 response, pushbutton 403 is used to indicate a NO or 2 response, and pushbutton 404 is used to ENTER or confirm a selection. In other embodiments, these functions (especially the functions of pushbuttons 402 and 403) may be performed by one or more input transducers (e.g., the input transducers of the listening device 120), thereby enabling the user to provide verbal responses to the test prompts. The process may proceed as follows:

1. User presses START. This initiates the self-test and programming process.

2. The user hears “adjust the right volume control until my voice can be understood”. This request repeats until the user presses enter.

3. While listening to this first message, the user adjusts the right volume control pushbuttons on the listening device 120. When the voice is comfortably understandable, the user presses ENTER. In some embodiments, the voice sound will be compressed audio with a narrow dynamic range such that virtually all users will be able to find a volume control position that allows the voice to be understood.

4. The user hears “adjust the left volume control until my voice can be understood”. This request repeats until the user presses enter.

5. While listening to this message, the user adjusts the left volume until the voice is comfortably understood and then presses ENTER. A microcontroller within the listening device 120 notes the volume control settings.

6. Following this initial adjustment of presentation level for both the right and left ears, a series of questions which can be answered with either “YES” or “NO” or “1” or “2” are presented to the user.

7. The questions are designed to allow the device to “zero in” on the proper fitting for both the right and left ears. The process can be roughly compared to that which an ophthalmologist employs when determining the best lens characteristics by asking questions of the patient while he or she is viewing various eye charts. Sample questions may be “Listen to this sound . . . [sound of woman's voice with traffic noise background] . . . Is she more understandable with setting #1 (pause while sound is processed according to setting #1) or is she more understandable with setting #2 (pause while sound is processed according to setting #2)? Press 1 or 2 to hear sound again with either setting and then press ENTER when you are at the best setting. If you are not sure which is best, simply select one or the other.”

8. The questions enable the configuration of the signal processor for the best fit.

9. The series of questions and resulting signal processing decisions which are made by the embedded microcontroller are judiciously chosen and evaluated such that the user's needs are confirmed. The process is similar, as mentioned above, to the process used in fitting eyeglasses, however without an audiologist or hearing specialist present.

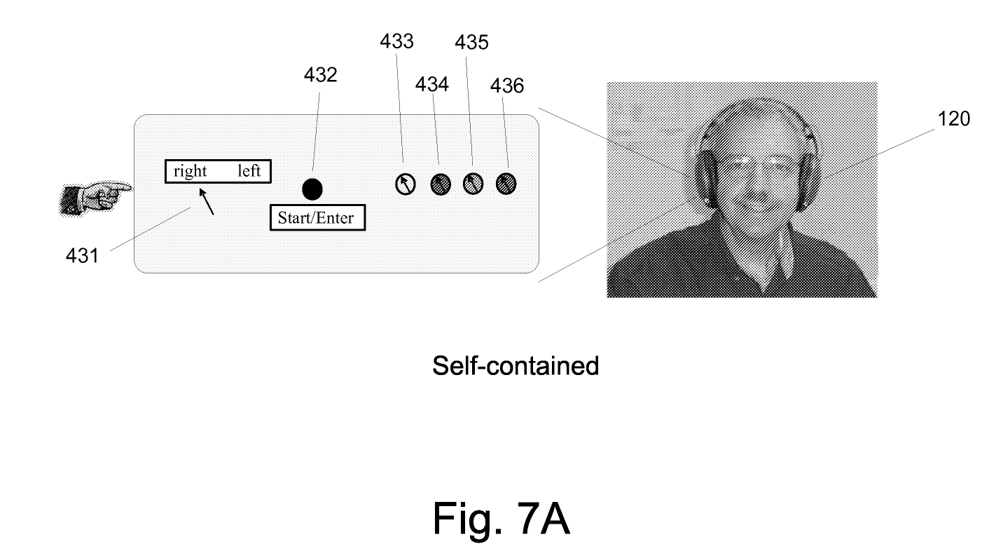

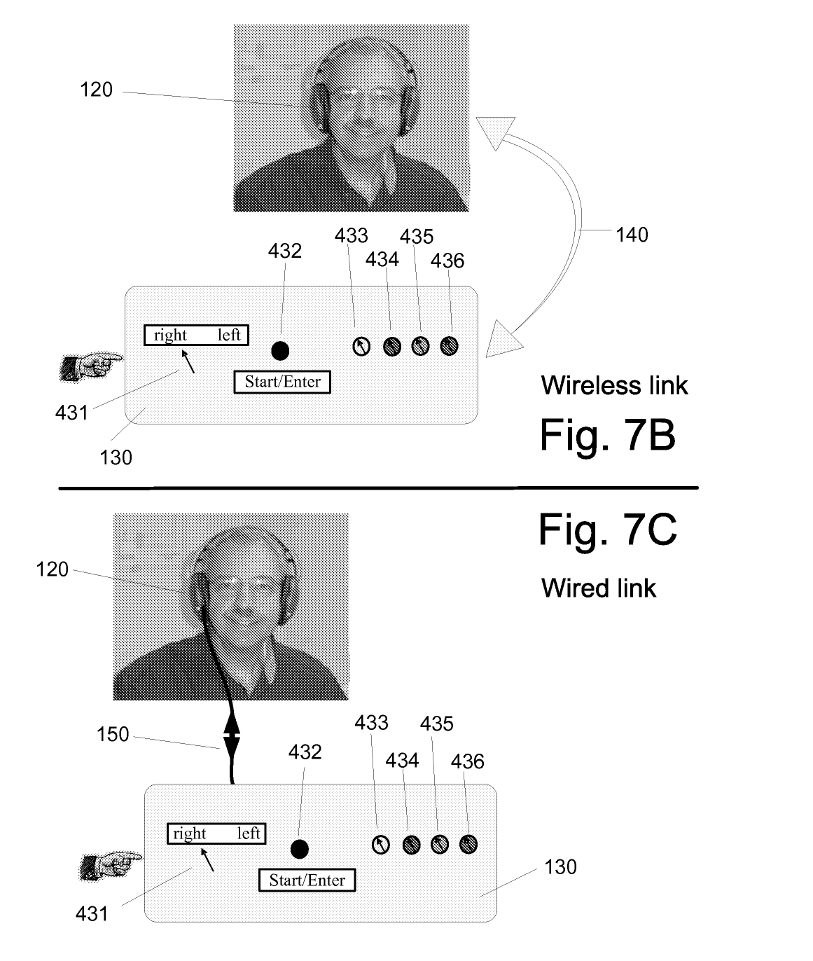

FIGS. 7A, 7B and 7C illustrate another exemplary configuration of user-operable controls that may be employed during self-test and programming of a listening device 120. In FIG. 7A, listening device 120 comprises user-operable controls 431 through 436 which may be located under a panel (such as panel 355 of FIG. 2) and are accessed only when the user wishes to cause the device 120 to enter programming mode. In FIG. 7B, user-operable controls 431 through 436 are located in an external programming module 130 which communicates with the listening device 120 via a wireless link 140. In FIG. 7C, user-operable controls 431 through 436 are located in an external programming module 120 which communicates with the listening device 120 via a wired link 150.

In this particular embodiment, the user-operable controls comprise a two-position selector 431 for right or left, a start button 432, and four controls 433 through 436 which adjust specific parameters. With this particular arrangement, the process may proceed as follows:

1. User selects either RIGHT or LEFT and presses START/ENTER. This initiates the self-test and programming process.

2. The user hears “adjust the right volume control until my voice can be understood”. This request repeats until the user presses enter.

3. While listening to this first message, the user adjusts the right volume control pushbuttons on the listening device 120. When the voice is comfortably understandable, the user presses ENTER. In some embodiments, the voice sound will be compressed audio with a narrow dynamic range such that virtually all users will be able to find a volume control position that allows the voice to be understood.

4. Following this initial adjustment of presentation level, a sound is presented, for example, the sound of a male voice in the right ear only, and the user is asked “adjust the four controls, starting with the leftmost (yellow) control such that the voice is most easily understood. Adjust the leftmost control first, then move to next control to the right and finally to the fourth control (rightmost). Then go back and readjust if desired. When you are satisfied with the adjustments, press START/ENTER.”

7. Other questions and adjustments will be made and the microcontroller will note the responses of the user to determine an efficacious configuration of the listening device 120.

8. Repeat steps 1 through 7 for the other ear.

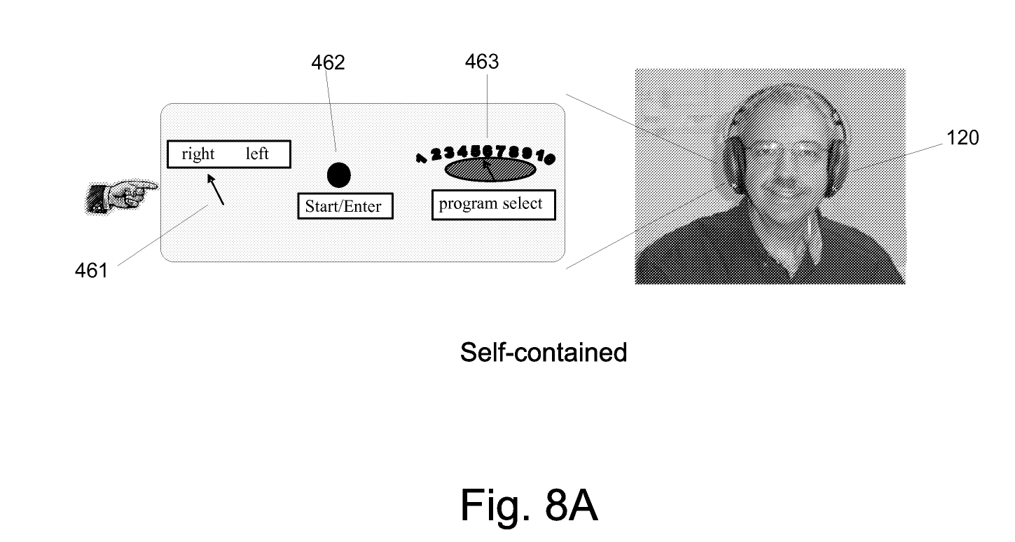

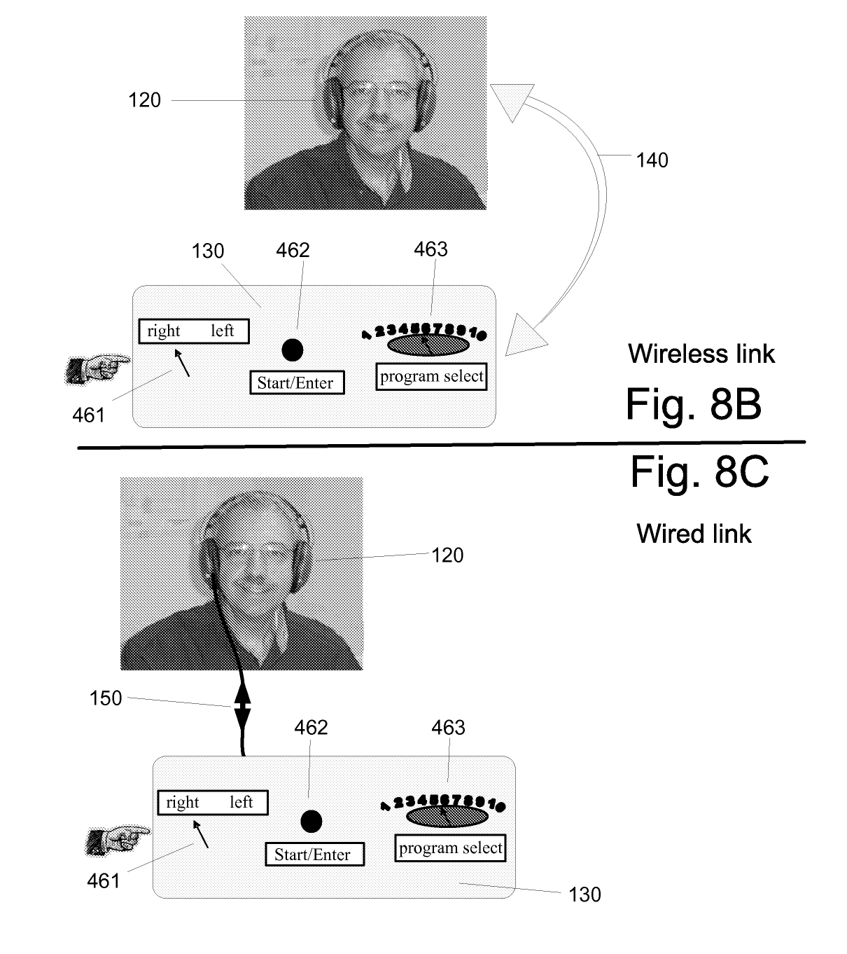

FIGS. 8A, 8B and 8C illustrate yet another exemplary configuration of user-operable controls that may be employed during self-test and programming of a listening device 120. In FIG. 8A, listening device 120 comprises user-operable controls 461, 462 and 463 which may be located under a panel (such as panel 355 of FIG. 2) and are accessed only when the user wishes to cause the device 120 to enter programming mode. In FIG. 8B, user-operable controls 461, 462 and 463 are located in an external programming device module 130 which communicates with the listening device 120 via a wireless link 140. In FIG. 8C, user-operable controls 461, 462 and 463 are located in an external programming module 130 which communicates with the listening device 120 via a wired link 150.

In this particular embodiment, the user-operable controls comprise a two-position selector 461 for right or left, a START/ENTER button 462, and a multiposition selector switch 463. Here, there are ten (there could be more or less) particular preprogrammed signal processing characteristics which are available to the user. He or she is asked to select the one which works best while listening to a series of sounds, including voices, speech in noise, musical sounds, etc.

Other arrangements of pushbuttons, switches and/or other controls, either self-contained within the listening device 120 or included in an external programming module 130 (linked by wired connection or wireless) are possible. Other specific series of questions and indeed other schemes for presenting choices to the user may be employed and still fall within the scope of this invention.

Although this invention has been described in terms of certain preferred embodiments, other embodiments that are apparent to those of ordinary skill in the art, including embodiments that do not provide all of the features and advantages set forth herein, are also within the scope of this invention. Rather, the scope of the present invention is defined only by reference to the appended claims and equivalents thereof.

What is claimed is:

1. A listening device comprising:
an input transducer configured to receive acoustic input signals;
a signal processor operatively connected to the input transducer and having programmable signal processing characteristics;
an output transducer operatively connected to the signal processor and configured to generate an audio output signal; and
a mode selector causing the listening device to enter a programming mode when actuated;
wherein the output transducer is configured to generate a series of test prompts to which the user responds when the listening device is in programming mode, and the processing characteristics of the signal processor are configured to be programmed based on signals received from the user in response to the test prompts.

2. The listening device of claim 1, wherein the listening device is configured as a headset with two circumaural earphones.

3. The listening device of claim 1, wherein the listening device comprises earbuds, supra-aural earphones, canalphones, or in-ear monitors.

4. The listening device of claim 1, wherein the listening device is configured to communicate with an external programming module when the listening device is in programming mode.

5. The listening device of claim 1, further comprising a self-contained programming module configured to generate the test prompts and program the processing characteristics of the signal processor when the listening device is in programming mode.

6. The listening device of claim 1, wherein the mode selector comprises a physical switch or pushbutton.

7. The listening device of claim 1, wherein the mode selector comprises an electronic control switch or software interrupt.

8. The listening device of claim 1, wherein the signal processor comprises an analog signal processor.

9. The listening device of claim 1, wherein the signal processor comprises a digital signal processor.

10. The listening device of claim 1, further comprising a plurality of user-operable controls configured to administer a self-test when the listening device is in programming mode.

11. The listening device of claim 1, wherein the listening device is configured to receive verbal responses to the test prompts from the user when the listening device is in programming mode.

12. The listening device of claim 1, further comprising a right earphone and a left earphone in operative communication with one another via a wireless link.

13. The listening device of claim 1, wherein the test prompts comprise digitized audio signals stored in a memory of a programming module.

14. A method for programming a listening device comprising:
providing a listening device with a programmable signal processor and an output transducer for generating sound delivered to a user;
administering a test to the user with the listening device in place on or in the user's ear, using test prompts delivered through the output transducer via a non-acoustic signal path; and
programming the signal processor based on the user's responses to the test prompts delivered through the output transducer.

15. The method of claim 14, wherein the listening device is configured as a headset with two circumaural earphones.

16. The method of claim 14, wherein the user provides verbal responses to the test prompts which are detected by an input transducer.

17. The method of claim 14, wherein the test is administered by a self-contained programming module housed within the listening device.

18. The method of claim 14, wherein the test is administered by an external programming module configured to communicate with the listening device via a wireless link or a wired link.

19. A system for programming a listening device, the system comprising:
a microcontroller configured to program the signal processing characteristics of the listening device;
a memory operatively connected to the microcontroller, the memory storing a plurality of test prompts;
means for presenting the test prompts to the user through the listening device via a non-acoustic signal path; and
means for receiving the user's responses to the test prompts for use by the microcontroller in programming the signal processing characteristics of the listening device.

20. The system of claim 19, wherein the microcontroller is located within an external programming module configured to communicate with the listening device via a wireless link.

21. The system of claim 19, wherein the microcontroller is located within an external programming module configured to communicate with the listening device via a wired link.

22. The system of claim 19, wherein the microcontroller is located within a self-contained programming module housed within the listening device.
